(19) United States
(12) Patent Application Publication
(10) Pub. No.: US 2009/0319284 A1
(43) Pub. Date: Dec. 24, 2009

(54) Method and device for verifying postage when moving postal articles over an electronic parcel compartment system

(76) Inventors: Boris Mayer, Bonn (DE); Sara Freitag, Bonn (DE)

Correspondence Address: MARSHALL, GERSTEIN & BORUN LLP, 233 SOUTH WACKER DRIVE, 6300 SEARS TOWER, CHICAGO, IL, 60606-6357, US

(21) Appl. No.: 11/658,682

(22) PCT Filed: Jun. 1, 2005
(86) PCT No.: PCT/EP05/05854

§ 371 Date: Nov. 20, 2007

(30) Foreign Application Priority Data
Jul. 26, 2004 (DE) 10 2004 036 176.2

(51) Int. Cl. G06Q 10/00

(52) U.S. Cl. 705/1

(57) ABSTRACT

A method for verifying postage when moving postal articles over an electronic parcel compartment system, during which non-recurring identification codes are allocated for postage stamps and stored in a storage means which associated status indicators. When a postage stamp with an identification codes is output, the associated status indicator is set to 1, whereas non-allocated identification codes have status indicator 2. In addition, identification codes that had been allocated with a postage stamp that, however, had already served for a delivery of a postal article in a parcel compartment system, are likewise set to status 2. If an identification code, which has not been stored in the storage means or the status indicator thereof is 2, is detected when placing a postal article in a parcel compartment system, a processing means releases a signal. This signal initiates a refusal to accept the postal article and/or initiates a storing of the customer data of the customer who wanted to insert the postal article. The invention also relates to a parcel compartment system for carrying out the disclosed method.

The invention relates to a method for verifying postage payment when mailpieces (for example, parcels, goods shipments or other postal articles) are conveyed via an electronic parcel deposit box facility.

The invention also relates to a device for verifying postage payment when mailpieces are conveyed via an electronic parcel deposit box facility.

In addition to the use of locker compartment facilities for storing, for example, luggage or bank documents, the use of facilities specifically configured for delivering and picking up goods shipments or mailpieces is likewise known. Such electronic parcel deposit box facilities make it possible for a deliverer to deposit mailpieces into a lockable compartment of the facility, after which the recipient of the mailpiece is normally informed about the delivery. The recipient can then pick up the mailpiece from the facility at any desired point in time, for which purpose, for example, an individual access code is transmitted to him.

Electronic parcel deposit box facilities and associated methods have the advantage that, for the shipment to be delivered, a customer does not have to be present at his home address, as is normally the case, but rather the mailpiece can be deposited into a parcel deposit box facility either right away or else after an unsuccessful delivery attempt. Consequently, after an unsuccessful delivery attempt, no notification is left behind for the recipient with which he then has to pick up the mailpiece during fixed opening hours of a post office branch, but rather, his flexibility is considerably enhanced through the use of the parcel deposit box facility.

Another advantage of electronic parcel deposit box facilities is that the facilities can also be used by a customer to drop off and send mailpieces. The mailpieces can be, for example, returned shipments that are to be returned by the recipient via a transportation service provider. Another possibility is that this shipment is a mailpiece originating with a customer who deposits it into a parcel deposit box facility where it is picked up by a service provider and delivered to a recipient.

In order to implement a sending function in an electronic parcel deposit box facility, first and foremost, it is necessary to ensure correct payment transactions or payment verification for the mailpiece in question. For this purpose, it is a known procedure, for instance, similar to conventional locker compartment facilities, to employ a means for payment transactions such as cash slots or card readers. It is also advantageous to use value labels such as stamps or other labels indicating a stored payment value which customers can apply onto mailpieces, thereby franking them. Such value labels are available to the customer, for example, in post office branches, via the Internet or directly at a parcel deposit box facility, and they are applied onto a parcel by the customer. If this mailpiece is not to be dropped off at a post office branch for mailing, but rather is to be placed into a parcel deposit box facility for pick-up, then there is a need for an effective payment verification, since no manual verification can be carried out at a parcel deposit box facility.

Therefore, the objective of the invention is to provide a method for payment verification in conjunction with the conveyance of mailpieces via an electronic parcel deposit box facility.

Another objective of the invention is to provide a parcel deposit box facility for carrying out the method.

According to the invention, this objective is achieved by a method having the features of the independent Claim 1 and by a device having the features of the independent Claim 5. Additional advantageous embodiments of the method can be gleaned from the subordinate Claims 2 to 4 and 6.

The method according to the invention for payment verification in conjunction with the conveyance of mailpieces via an electronic parcel deposit box facility provides that several unique identification codes are stored in a storage means that is connected to a device for issuing postage payment labels. An identification code from the storage means is assigned and the identification code is associated with a postage payment label in a processing means of the device. The device issues a postage payment label that contains at least the assigned identification code. In addition, the postage payment label can contain the address of the sender and/or a recipient address. The device for creating and selling postage payment labels can be a parcel deposit box facility or an autonomous vending machine. In the especially preferred embodiment shown here, the device is integrated into a parcel deposit box facility so that postage payment labels can be purchased at the facility that can then be used immediately or at a later point in time for depositing mailpieces into the facility.

According to the invention, the identification code in the storage means is characterized by at least two status displays 1 and 2, the first status display 1 indicating that a postage payment label bearing this identification code has been printed and the second status display 2 indicating that no postage payment label bearing this identification code has been printed. The status display of an identification code is advantageously set to 2 in the storage means at the beginning of the process. The status display of an identification code is set to 1 after the device has issued a postage payment label bearing the assigned identification code. The status display of an identification code is set to 2 again when the identification code of a postage payment label is detected at a parcel deposit box facility and the appertaining mailpiece is deposited into the parcel deposit box facility.

If a customer wants to send a mailpiece via an electronic parcel deposit box facility, the identification code of a postage payment label on the mailpiece is detected at the parcel deposit box facility and compared to the identification codes and to the appertaining status displays in the storage means. In this process, a detected identification code that is not stored in the storage means or whose status display is 2 triggers a signal. The signal actuates a function of the parcel deposit box facility which, for example, initiates refusing to accept the mailpiece with the detected identification code. Moreover, the signal can also actuate a function of the parcel deposit box facility that initiates storing the customer data of the customer who is trying to deposit the mailpiece.

The device for issuing postage payment labels is preferably likewise an electronic parcel deposit box facility. However, it can also be an autonomous vending machine for issuing postage payment labels which is connected to the storage means which, in turn, is connected to one or more parcel deposit box facilities.

The invention also comprises a parcel deposit box facility for carrying out the method. For this purpose, the parcel deposit box facility has a storage means connected to the device to store identification codes and associated status displays. It also comprises a detection means for detecting the identification code of a postage payment label on a mailpiece as well as a processing means for changing the status display of an identification code once the identification code of a postage payment label has been detected at a parcel deposit box facility and the associated mailpiece has been deposited into the parcel deposit box facility (setting the status display from 1 to 2), or once the identification code has been assigned (setting the status display from 2 to 1). The device has processing means with which an identification code detected at a parcel deposit box facility can be compared to identification codes stored in the storage means and it has a means for generating a signal in case the detected identification code is not stored in the storage means or if the status display of the identification code is set at 2.

The storage means can be situated in the device or at a location that is physically remote from the device, whereby it is either permanently or temporarily connected to the device.

The method according to the invention and the associated parcel deposit box facility have various advantages. An essential advantage is that an effective payment verification can take place that allows the recognition of various cases of fraud. For instance, the case can be recognized where postage payment labels with incorrect identification codes are used that were not generated for the production of postage payment labels. The security can be increased in that no continuous identification code groupings but rather, for example, several groups or interrupted series are stored in the storage means for purposes of being assigned. Thus, the probability of a coincidental hit is sufficiently reduced.

Secondly, a case of fraud can be recognized in which a postage payment label with one identification code is used multiple times for sending a mailpiece, since the status display of such a code is set at 2 and, in this case, the acceptance of the mailpiece is preferably refused. Hence, the only postage payment labels with identification codes that are accepted are those whose status display is 1, since these are only postage payment labels that have been sold but not yet used.

Conventional methods for postage verification are limited to the after-the-fact verification of a payment after a mailpiece has already been accepted into the shipping process. The method according to the invention in conjunction with a parcel deposit box facility has the advantage that the verification of a payment can already be made before the mailpiece is accepted so that the possibility exists, for instance, to prevent the acceptance. Moreover, the same method can be used to simplify the manual payment verification if the verification of the validity of the label is carried out by an employee using, for example, a hand-held scanner.

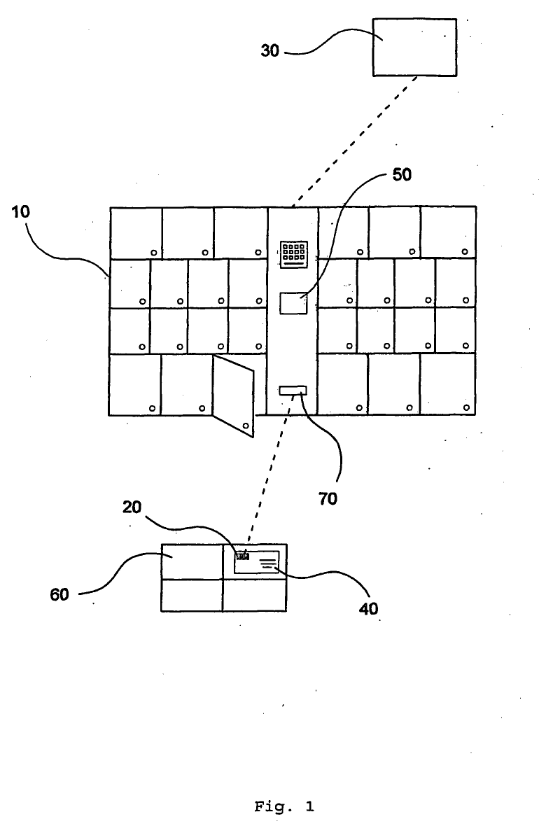

Additional advantages, special features and practical refinements of the invention can be gleaned from the subordinate claims and from the presentation below of a preferred embodiment making reference to FIG. 1.

FIG. 1 shows an especially preferred embodiment of a parcel deposit box facility 10 for carrying out the method according to the invention. The parcel deposit box facility preferably has several compartments where a customer and/or a deliverer can deposit mailpieces, and it encompasses a control unit. The control unit comprises, for instance, a means for detecting customer identification, a process in which customer cards are read in, a customer enters his identification information using a keyboard or a touchscreen, or else he identifies himself via other identification methods (e.g. biometric methods, identification via cell phones or other digital communication devices). Furthermore, display means such as a terminal by means of which a menu dialog can be held with the customer are also advantageous. A successful identification of the customer grants access to various menu functions which can also include the depositing of a mailpiece for shipping.

A storage means 30 in which at least the identification codes 20 that are to be assigned for issuing postage payment labels 40 is connected to the control unit. Here, the storage means can be situated in the parcel deposit box facility or at a location that is physically remote from it. Since it has proven to be advantageous to use several parcel deposit box facilities in an overall system and to administer them centrally, the storage means is preferably at a remote location from the parcel deposit box facility in a central data processing unit. However, it can also be advantageous to equip each parcel deposit box facility with one storage means for storing identification codes so that the invention encompasses both embodiments.

The identification codes have at least two status displays 1 and 2 of which the first status display 1 indicates that a postage payment label with this identification code has been printed and the second status display 2 indicates that no postage payment label with this identification code has been printed. When the process starts, the status displays of all of the identification codes are preferably set at 2, since no postage payment labels have been produced and sold yet. The status display of an identification code is set to 1 after the device has issued a postage payment label bearing the assigned identification code. Once the identification code of a postage payment label is detected at a parcel deposit box facility and the associated mailpiece 60 is deposited into the parcel deposit box facility, then the status display of an identification code is reset to 2 and the identification code can be assigned again, whereby this can be done immediately or else after a latency time interval that can be defined as desired.

The parcel deposit box facility also has a processing means 50 in which the identification codes are assigned to postage payment labels that are printed out and sold via the facility. The processing means also serves to compare an identification code detected at the facility to the stored identification codes. Detection means 70 are provided to detect an identification code, and this means can be, for example, a barcode scanner. If a customer wants to deposit a parcel into the parcel deposit box facility for shipping, the identification code 20 of the appertaining postage payment label 40 is scanned in and a comparison is carried out in the processing means 50. When a mailpiece is handed in at the counter in a post office or at another staffed drop-off location, the identification code is likewise scanned in using a preferably mobile detection means 70, after which a processing means or a separate display means indicates that the detected identification code is invalid. In this case, the acceptance of the mailpiece can likewise be refused.

First of all, during the comparison in the processing means, it is checked whether the detected identification code belongs to the identification codes assigned by the storage means. If this is not the case, then this is an incorrect identification code that constitutes a case of fraud. Secondly, if it is an identification code that has been assigned but whose status display is set at 2, this is likewise recognized as a case of fraud, since no unused postage payment label with this identification code has been put into circulation. In both of these cases, the processing means 50 triggers a signal.

The signal triggered by the processing means 50 can actuate a function of the parcel deposit box facility that preferably causes a refusal of acceptance of the parcel. This can comprise, for example, a message on a display to the effect that a mailpiece cannot be accepted. In an especially preferred embodiment of the invention, the customer data of the customer that was detected and associated at the time of his identification at the parcel deposit box facility is stored.

Since the possibility preferably exists that postage payment labels can be purchased at branch offices, via the Internet, vending machines or directly at the electronic parcel deposit box facility, it is advantageous to ensure a payment verification for all of these sales modalities. If all of the assigned identification codes of the entire system are stored in the storage means 30, then all of the sold postage payment labels can be verified when a parcel is deposited into a parcel deposit box facility. In another embodiment of the invention, the grouping of identification codes to be verified is restricted and only postage payment labels of certain sales modalities are checked. For example, it can be provided that a comparison is carried out exclusively with identification codes that were produced and sold via an electronic parcel deposit box facility. In this manner, the work involved in maintaining databases and the procedures for verification at the parcel deposit box facility are considerably reduced.

### LIST OF REFERENCE NUMERALS

10 parcel deposit box facility
11 device for issuing postage payment labels
20 identification code
30 storage means
40 postage payment label
50 processing means
60 mailpiece
70 detection means

1. A method for verifying postage payment when mailpieces are conveyed via an electronic parcel deposit box facility, in which method several unique identification codes are stored in a storage means that is connected to a device for issuing postage payment labels, in which an identification code from the storage means is assigned, the identification code is associated with a postage payment label in a processor of the device and the device issues a postage payment label that contains at least the assigned identification code, wherein:
the device is integrated into a parcel deposit box facility for issuing postage payment labels;
the identification code on the postage payment label belongs to an identification code grouping that is associated with the modality of the sale of a postage payment label via an electronic parcel deposit box facility;
the identification code in the storage means is characterized by at least two status displays 1 and 2, the first status display 1 indicating that a postage payment label bearing this identification code has been printed and the second status display 2 indicating that no postage payment label bearing this identification code has been printed;
the status display of an identification code is set to 2 in the storage means at the beginning of the process;
the status display of an identification code is set to 1 after the device has issued a postage payment label bearing the assigned identification code;
the status display of an identification code is set to 2 when the identification code of a postage payment label is detected at a parcel deposit box facility and the appertaining mailpiece is deposited into the parcel deposit box facility;
detection of a customer identification of a customer in a means of a control unit of the parcel deposit box facility;
the identification code of a postage payment label on a mailpiece is detected at the parcel deposit box facility and compared exclusively to identification codes that were produced and sold via an electronic parcel deposit box facility and to the appertaining status displays in the storage means, whereby a detected identification code that is not stored in the storage means or whose status display is 2 triggers a signal; and
the signal actuates at least one function of the parcel deposit box facility that initiates storing the customer data of the customer who is trying to deposit the mailpiece.

2. The method according to claim 1, wherein
the signal actuates a function of the parcel deposit box facility which initiates refusing to accept the mailpiece with the detected identification code.

3. A parcel deposit box facility for carrying out the method according to claim 1, wherein
the parcel deposit box facility comprises:
a device for issuing postage payment labels;
a storage means connected to the parcel deposit box facility to store identification codes and associated status displays, whereby the identification codes belong to an identification code grouping that is associated with the modality of the sale of a postage payment label via an electronic parcel deposit box facility;
a control unit with means for detecting customer information when a mailpiece is deposited into the parcel deposit box facility;
a detector for detecting the identification code of a postage payment label on a mailpiece;
a processor for setting a status display of an identification code to 2 once the identification code of a postage payment label has been detected at a parcel deposit box facility and the associated mailpiece has been deposited into the parcel deposit box facility;
a process with which an identification code detected at a parcel deposit box facility is compared exclusively to identification codes stored in the storage means, which were produced and sold via an electronic parcel deposit box facility;
a means for generating a signal in case the detected identification code is not stored in the storage means or if the status display of the identification code is set at 2; and
a means for storing detected customer data.

4. The parcel deposit box facility according to claim 3, wherein
the storage means is situated in the parcel deposit box facility.

5. The parcel deposit box facility according to claim 3, wherein
the storage means is situated at a location that is physically remote from the parcel deposit box facility and it is either permanently or temporarily connected to the facility.
